(19) United States
(12) Patent Application Publication
(10) Pub. No.: US 2014/0108734 A1
(43) Pub. Date: Apr. 17, 2014

(54) METHOD AND APPARATUS FOR SAVING PROCESSOR ARCHITECTURAL STATE IN CACHE HIERARCHY

(71) Applicant: Advanced Micro Devices, Inc., Sunnyvale, CA (US)

(72) Inventors: Paul Edward Kitchin, Austin, TX (US); William L. Walker, Fort Collins, CO (US)

(21) Appl. No.: 13/653,744

(22) Filed: Oct. 17, 2012

(51) Int. Cl. G06F 12/08

(52) U.S. Cl. 711/122; 711/E12.017; 711/119; 711/E12.043

(57) ABSTRACT

A processor includes a first processing unit and a first level cache associated with the first processing unit and operable to store data for use by the first processing unit used during normal operation of the first processing unit. The first processing unit is operable to store first architectural state data for the first processing unit in the first level cache responsive to receiving a power down signal. A method for controlling power to processor including a hierarchy of cache levels includes storing first architectural state data for a first processing unit of the processor in a first level of the cache hierarchy responsive to receiving a power down signal and flushing contents of the first level including the first architectural state data to a first lower level of the cache hierarchy prior to powering down the first level of the cache hierarchy and the first processing unit.

### BACKGROUND

The disclosed subject matter relates generally to electronic devices having multiple power states and, more particularly, to a method and apparatus for saving the architectural state of a processor in the cache hierarchy.

The ever increasing advances in silicon process technology and reduction of transistor geometry makes static power (leakage) a more significant contributor in the power budget of integrated circuit devices, such as processors (CPUs). To attempt to reduce power consumption, some devices have been equipped to enter one or more reduced power states. In a reduced power state, a reduced clock frequency and/or operating voltage may be employed for the device.

To save system power, CPU cores can power off when not being utilized. When the system requires the use of that CPU core at a later time, it will power up the CPU core and start executing on that CPU core again. When a CPU core powers off, the architectural state of that CPU core will be lost. However, when the CPU core is powered up again, it will require that architectural state be restored to continue executing software. To avoid running lengthy boot code to restore the CPU core back to its original state, it is common for CPU cores to save its architectural state before powering off and then restoring that state again when powering up. The CPU core stores the architectural state in a location that will retain power across the CPU core power down period.

This process of saving and restoring architectural state is time-critical for the system. Any time wasted before going into the power down state is time that the core could have been powered down. Therefore, longer architectural state saves waste power. Also, any wasted time while restoring architectural state on power-up adds to the latency that the CPU core can respond to a new process, thus slowing down the system. Also, the memory location where the architectural state is saved across low power states must be secure. If a hardware or software entity could maliciously corrupt this architectural state when the CPU core is in a low power state, the CPU core would restore a corrupted state and could be exposed to a security risk.

Conventional CPU cores save the architectural state to various locations to facilitate a lower power state. For example, the CPU may save the architectural state to a dedicated SRAM array or to the system memory ((e.g., DRAM). Dedicated SRAM allows faster save and restore times and improved security, but requires dedicated hardware, resulting in increased cost. Saving to system memory uses existing infrastructure, but increases save and restore times and decreases security.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF EMBODIMENTS

The following presents a simplified summary of only some aspects of embodiments of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

Some embodiments include a processor including a first processing unit and a first level cache associated with the first processing unit and operable to store data for use by the first processing unit used during normal operation of the first processing unit. The first processing unit is operable to store first architectural state data for the first processing unit in the first level cache responsive to receiving a power down signal.

Some embodiments include a method for controlling power to processor including a hierarchy of cache levels. The method includes storing first architectural state data for a first processing unit of the processor in a first level of the cache hierarchy responsive to receiving a power down signal and flushing contents of the first level including the first architectural state data to a first lower level of the cache hierarchy prior to powering down the first level of the cache hierarchy and the first processing unit.

### BRIEF DESCRIPTION OF THE DRAWINGS

The disclosed subject matter will hereafter be described with reference to the accompanying drawings, wherein like reference numerals denote like elements, and:

FIG. 1 is a simplified block diagram of a computer system operable to store architectural processor states in the cache hierarchy in accordance with some embodiments;

FIG. 2 is a simplified diagram of a cache hierarchy implemented by the system of FIG. 1, in accordance with some embodiments;

FIG. 3 is a simplified diagram of a level 1 cache including instruction and data caches that may be used in the system of FIG. 1, in accordance with some embodiments;

FIGS. 4-8 illustrate the use of the cache hierarchy to store processor architectural states during power down events, in accordance with some embodiments; and

FIG. 9 is a simplified diagram of a computing apparatus that may be programmed to direct the fabrication of the integrated circuit device of FIGS. 1-3, in accordance with some embodiments.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

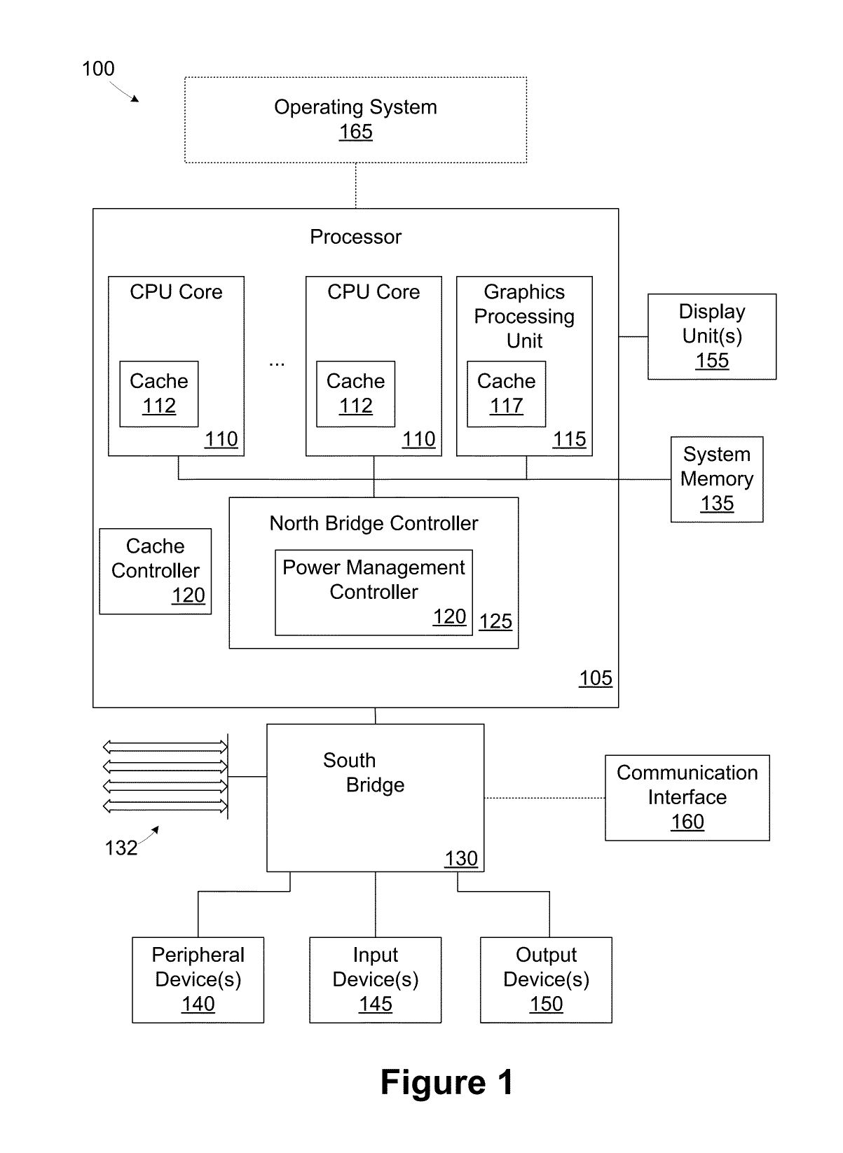

Referring now to the drawings wherein like reference numbers correspond to similar components throughout the several views and, specifically, referring to FIG. 1, the disclosed subject matter shall be described in the context of a computer system 100 including an accelerated processing unit (APU) 105. The APU 105 includes one or more central processing unit (CPU) cores 110 and their associated caches 112 (e.g., L1, L2, or other level cache memories), a graphics processing unit (GPU) 115 and its associated caches 117 (e.g., L1, L2, L3, or other level cache memories), a cache controller 119, a power management controller 120, a north bridge (NB) controller 125. The system 100 also includes a south bridge (SB) 130, and system memory 135 (e.g., DRAM). The NB controller 125 provides an interface to the south bridge 130 and to the system memory 135. To the extent certain exemplary aspects of the cores 110 and/or one or more cache memories 112 are not described herein, such exemplary aspects may or may not be included in various embodiments without limiting the spirit and scope of the embodiments of the present subject matter as would be understood by one of skill in the art.

In some embodiments, the computer system 100 may interface with one or more peripheral devices 140, input devices 145, output devices 150, and/or display units 155. A communication interface 160, such as a network interface circuit (NIC), may be connected to the south bridge 130 for facilitating network connections using one or more communication topologies (wired, wireless, wideband, etc.). It is contemplated that in various embodiments, the elements coupled to the south bridge 130 may be internal or external to the computer system 100, and may be wired, such as illustrated as being interfaces with the south bridge 130, or wirelessly connected, without affecting the scope of the embodiments of the present subject matter. The display units 155 may be internal or external monitors, television screens, handheld device displays, and the like. The input devices 145 may be any one of a keyboard, mouse, track-ball, stylus, mouse pad, mouse button, joystick, scanner or the like. The output devices 150 may be any one of a monitor, printer, plotter, copier or other output device. The peripheral devices 140 may be any other device which can be coupled to a computer: a CD/DVD drive capable of reading and/or writing to corresponding physical digital media, a universal serial bus (“USB”) device, Zip Drive, external floppy drive, external hard drive, phone, and/or broadband modem, router, gateway, access point, and/or the like. To the extent certain example aspects of the computer system 100 are not described herein, such example aspects may or may not be included in various embodiments without limiting the spirit and scope of the embodiments of the present application as would be understood by one of skill in the art. The operation of the system 100 is generally controlled by an operating system 165 including software that interfaces with the various elements of the system 100. In various embodiments the computer system 100 may be a personal computer, a laptop computer, a handheld computer, a tablet computer, a mobile device, a telephone, a personal data assistant (“FDA”), a server, a mainframe, a work terminal, a music player, smart television, and/or the like.

The power management controller 120 may be a circuit or logic configured to perform one or more functions in support of the computer system 100. As illustrated in FIG. 1, the power management controller 120 is implemented in the NB controller 125, which may include a circuit (or sub-circuit) configured to perform power management control as one of the functions of the overall functionality of NB controller 125. In some embodiments, the south bridge 130 controls a plurality of voltage rails 132 for providing power to various portions of the system 100. The separate voltage rails 132 allow some elements to be placed into a sleep state while others remain powered.

In some embodiments, the circuit represented by the NB controller 125 is implemented as a distributed circuit, in which respective portions of the distributed circuit are configured in one or more of the elements of the system 100, such as the processor cores 110, but operating on separate voltage rails 132, that is, using a different power supply than the section or sections of the cores 110 functionally distinct from the portion or portions of the distributed circuit. The separate voltage rails 132 may thereby enable each respective portion of the distributed circuit to perform its functions even when the rest of the processor core 110 or other element of the system 100 is in a reduced power state. This power independence enables embodiments that feature a distributed circuit, distributed controller, or distributed control circuit performing at least some or all of the functions performed by NB controller 125 shown in FIG. 1. In some embodiments, the power management controller 120 controls the power states of the various processing units 110, 115 in the computer system 100.

Instructions of different software programs are typically stored on a relatively large but slow non-volatile storage unit (e.g., internal or external disk drive unit). When a user selects one of the programs for execution, the instructions of the selected program are copied into the system memory 135, and the processor 105 obtains the instructions of the selected program from the system memory 135. Some portions of the data are also loaded into cache memories 112 of one or more of the cores 110.

The caches 112, 117 are smaller and faster memories (i.e., as compared to the system memory 135) that store copies of instructions and/or data that are expected to be used relatively frequently during normal operation. The cores 110 and/or the GPU 115 may employ a hierarchy of cache memory elements.

Instructions or data that are expected to be used by a processing unit 110, 115 during normal operation are moved from the relatively large and slow system memory 135 into the cache 112, 117 by the cache controller 119. When the processing unit 110, 115 needs to read or write a location in the system memory 135, the cache controller 119 first checks to see whether the desired memory location is included in the cache 112, 117. If this location is included in the cache 112, 117 (i.e., a cache hit), then the processing unit 110, 115 can perform the read or write operation on the copy in the cache 112, 117. If this location is not included in the cache 112, 117 (i.e., a cache miss), then the processing unit 110, 115 needs to access the information stored in the system memory 135 and, in some cases, the information may be copied from the system memory 135 cache controller 119 and added to the cache 112, 117. Proper configuration and operation of the cache 112, 117 can reduce the latency of memory accesses below the latency of the system memory 135 to a value close to the value of the cache memory 112, 117.

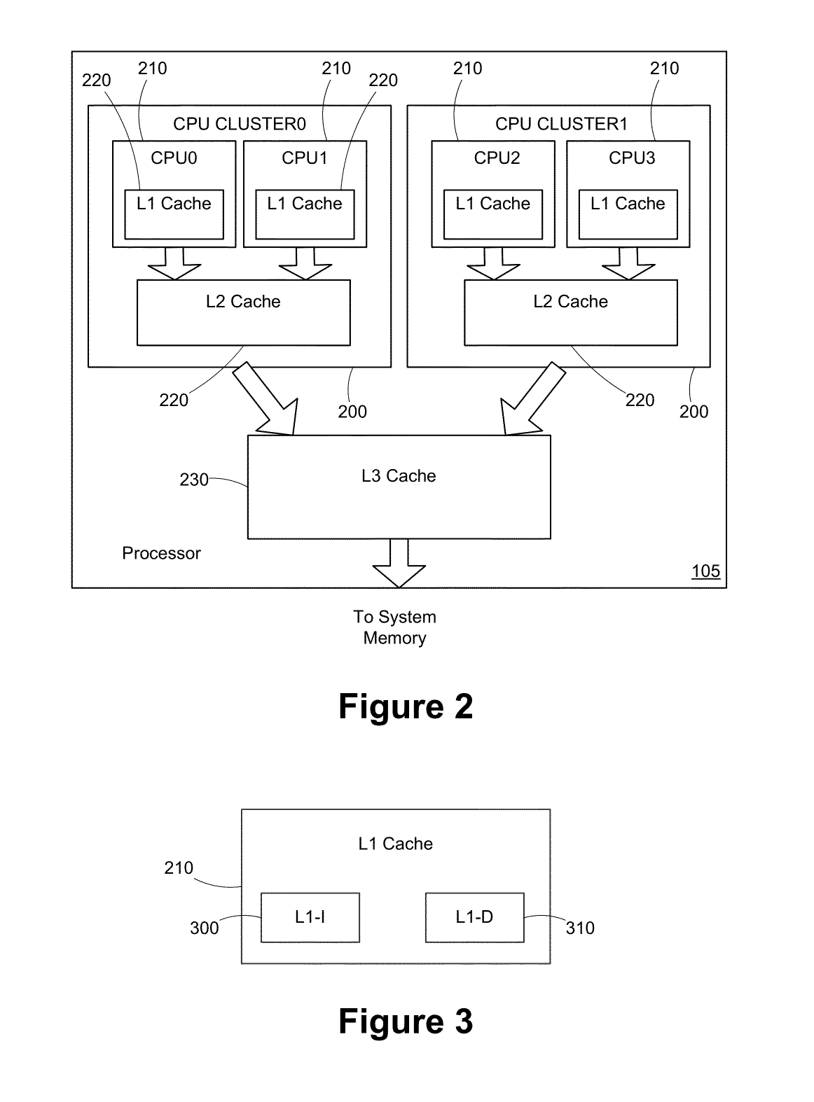

Turning now to FIG. 2, a block diagram illustrating the cache hierarchy employed by the processor 105. In the illustrated embodiment, the processor 105 employs a hierarchical cache that divides the cache into three levels known as the L1 cache, the L2 cache, and the L3 cache. The cores 110 are grouped into CPU clusters 200. Each core 110 has its own L1 cache 210, each cluster 200 has an associated L2 cache 220, and the clusters 200 share an L3 cache 230. The system memory 135 is downstream of the L3 cache 230. In the cache hierarchy, the speed generally decreases with level, but the size generally increases. For example, the L1 cache 210 is typically smaller and faster memory than the L2 cache 220, which is smaller and faster than the L3 cache 230. The largest level in the cache hierarchy is the system memory 135, which is also slower than the cache memories 210, 220, 230. A particular core 110 first attempts to locate needed memory locations in the L1 cache and then proceeds to look successively in the L2 cache, the L3 cache, and finally the system memory 135 when it is unable to find the memory location in the upper levels of the cache. The cache controller 119 may be a centralized unit that manages all of the cache hierarchy levels, or it may be distributed. For example, each cache 210, 220, 230 may have its own cache controller 119, or some levels may share a common cache controller 119.

In some embodiments, the L1 cache can be further subdivided into separate L1 caches for storing instructions, L1-I 300, and data, L1-D 310, as illustrated in FIG. 3. The L1-I cache 300 can be placed near entities that require more frequent access to instructions than data, whereas the L1-D cache 310 can be placed closer to entities that require more frequent access to data than instructions. The L2 cache 220 is typically associated with both the L1-I and L1-D caches and can store copies of instructions or data retrieved from the L3 cache 230 and the system memory 135. Frequently used instructions are copied from the L2 cache into the L1-I cache 300 and frequently used data can be copied from the L2 cache into the L1-D cache 310. The L2 and L3 caches 220, 230 are commonly referred to as unified caches.

In some embodiments, the power management controller 120 controls the power states of the cores 110. When a particular core 110 is placed in a power down state (e.g., a C6 state), the core 110 saves its architectural state in its L1 cache 220 responsive to a power down signal from the power management controller 120. In embodiments where the L1 cache 220 includes an L1 -I cache 300 and an L1 -D cache 310, the L1 -D cache 310 is typically used for storing the architectural state. In this manner, the system 100 uses the cache hierarchy to facilitate the architectural state save/restore for power events. When the core 110 is powered down, the cache contents are automatically flushed to the next lower level in the cache hierarchy by the cache controller 119. In the illustrated embodiment, each core has a designated memory location for storing its architectural state. When the particular core 110 receives a power restore instruction or signal, it retrieves its architectural state based on the designated memory location. Based on the designated memory location, the cache hierarchy will locate the architectural state data in the lowest level that the data was flushed down to in response to power down events. If the power down event is canceled by the power management controller 120 prior to flushing the L1 cache 210, the architectural state may be retrieved therefrom.

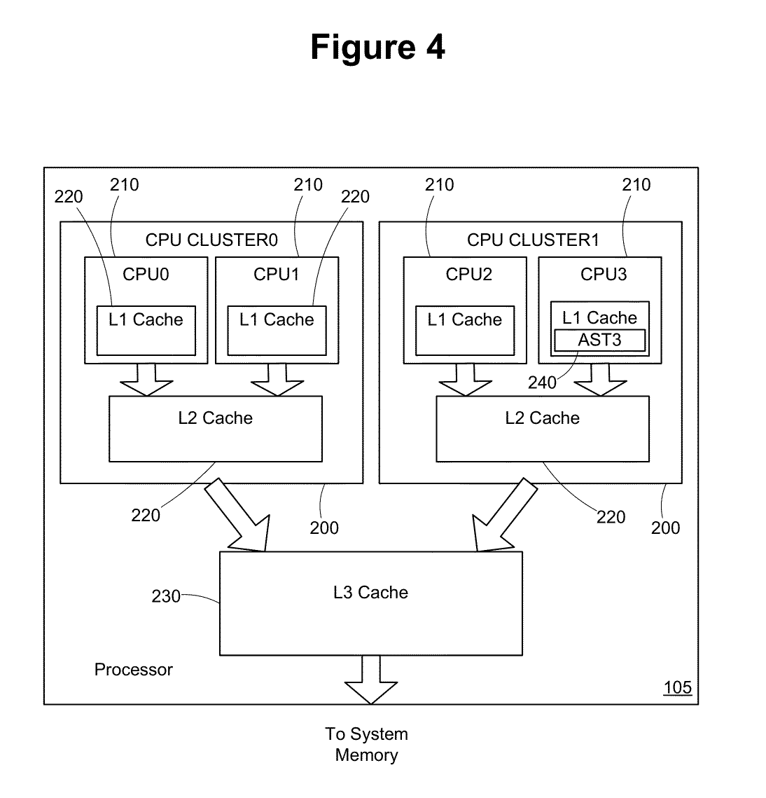

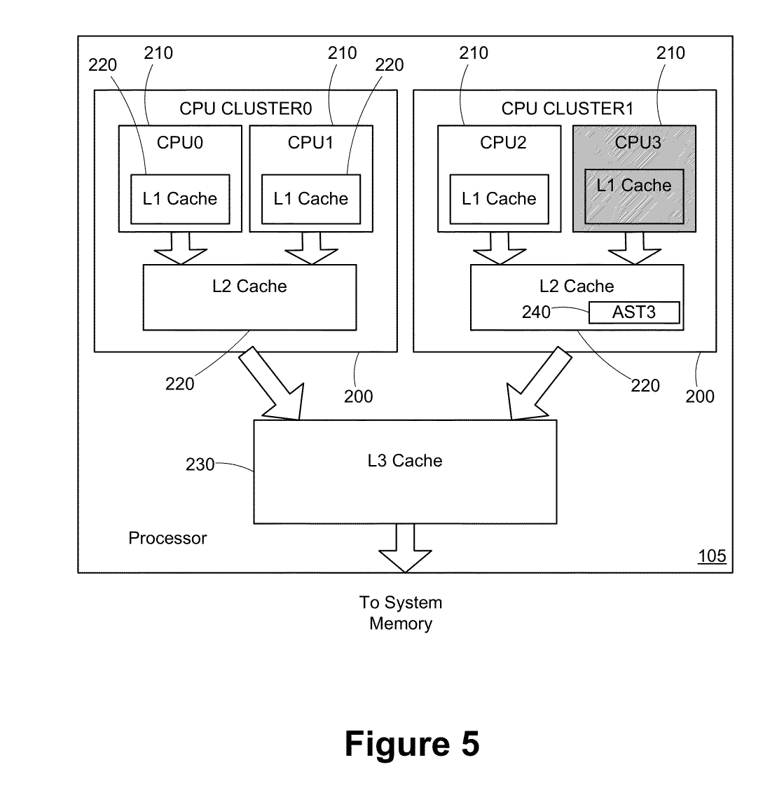

As shown in FIG. 4, the power management controller 120 instructs CPU3 to transition to a low power state. CPU3 stores its architectural state 240 (AST3) in its L1 cache 220. When CPU3 is powered down, its L1 cache 220 is flushed by the cache controller 119 to the L2 cache 220 for the CPU cluster 1, as shown in FIG. 5. The powering down of CPU3 is denoted by the gray shading.

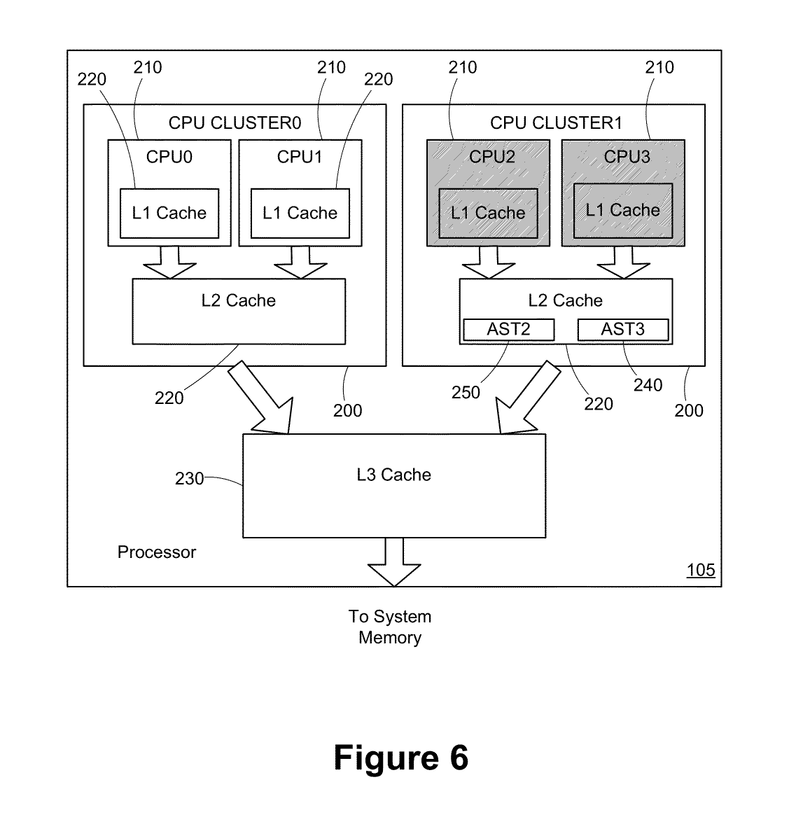

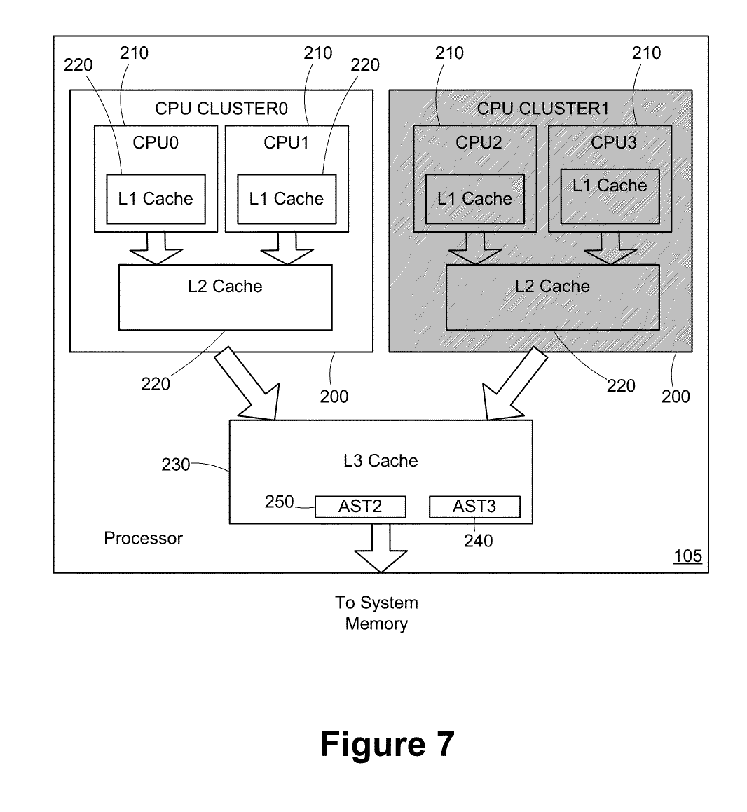

As shown in FIG. 6, CPU2 is also instructed to power down by the power management controller 120, and CPU2 stores its architectural state 250 (AST2) in its L1 cache 220. CPU2 powers down and its state 250 is flushed by the cache controller 119 to the L2 cache 220. Since both cores 110 in CPU cluster 1 are powered down, the whole cluster may be powered down, which flushes the L2 cache 220 to the L3 cache 230, as shown in FIG. 7.

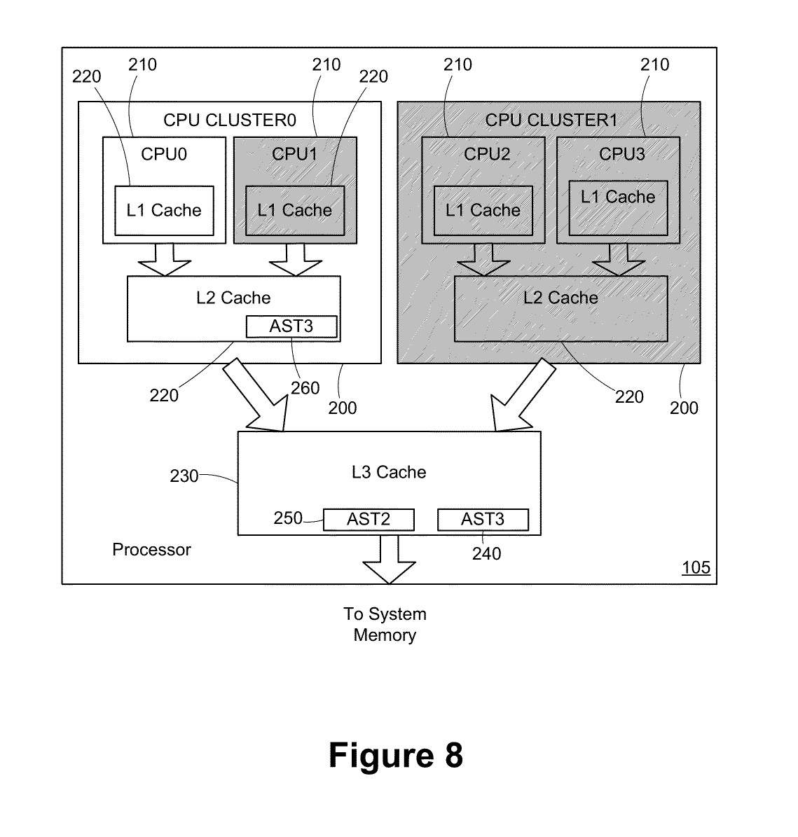

If CPU1 were to be powered down by the power management controller 120, it would save its architectural state 260 (ASTATE1) to its L1 cache 210 and then the cache controller 119 would flush to the L2 cache 220, as shown in FIG. 8. In this current state, only CPU0 is running, which is a common scenario for CPU systems with only one executing process.

If CPU1 were to receive a power restore instruction or signal, it would only need to fetch its architectural state from the CPU Cluster 0 L2 cache 220. If CPU2 or CPU3 were to power up, they would need to fetch their respective states from the L3 cache 230. Because the cores 110 use designated memory locations for their respective architectural state data, the restored core 110 need only request the data from the designated location. The cache controller 119 will automatically locate the cache level in which the data resides. For example, if the architectural state data is stored in the L3 cache 230, the core 110 being restored will get misses in the L1 cache 210 and the L2 cache 220, and eventually get a hit in the L3 cache 230. The cache hierarchy logic will identify the location of the architectural state data and forward it to the core 110 being restored.

If all cores 110 were to power down, then the L3 cache 230 would be flushed to system memory 135 and the entire CPU system could power down. The cache controller 119 would locate the architectural state data in the system memory 135 during a power restore following misses in the higher levels of the cache hierarchy.

For a processor system with multiple levels of cache hierarchy, using the cache hierarchy to save the architectural state has the benefit of low latency, since the architectural state data is only flushing as far down in the cache hierarchy as needed to support the power state. This approach also uses existing cache flushing infrastructure to save data to the caches and subsequently flush the data from one cache to the next, so the design complexity is low.

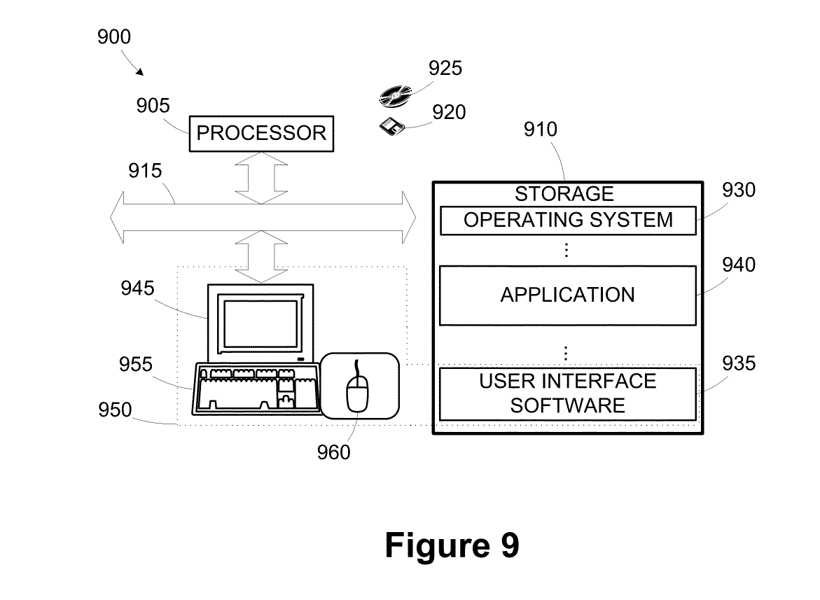

FIG. 9 illustrates a simplified diagram of selected portions of the hardware and software architecture of a computing apparatus 900 such as may be employed in some aspects of the present subject matter. The computing apparatus 900 includes a processor 905 communicating with storage 910 over a bus system 915. The storage 910 may include a hard disk and/or random access memory (RAM) and/or removable storage, such as a magnetic disk 920 or an optical disk 925. The storage 910 is also encoded with an operating system 930, user interface software 935, and an application 940. The user interface software 935, in conjunction with a display 945, implements a user interface 950. The user interface 950 may include peripheral I/O devices such as a keypad or keyboard 955, mouse 960, etc. The processor 905 runs under the control of the operating system 930, which may be practically any operating system known in the art. The application 940 is invoked by the operating system 930 upon power up, reset, user interaction, etc., depending on the implementation of the operating system 930. The application 940, when invoked, performs a method of the present subject matter. The user may invoke the application 940 in conventional fashion through the user interface 950. Note that although a stand-alone system is illustrated, there is no need for the data to reside on the same computing apparatus 900 as the simulation application 940 by which it is processed. Some embodiments of the present subject matter may therefore be implemented on a distributed computing system with distributed storage and/or processing capabilities.

It is contemplated that, in some embodiments, different kinds of hardware descriptive languages (HDL) may be used in the process of designing and manufacturing very large scale integration circuits (VLSI circuits), such as semiconductor products and devices and/or other types semiconductor devices. Some examples of HDL are VHDL and Verilog/Verilog-XL, but other HDL formats not listed may be used. In one embodiment, the HDL code (e.g., register transfer level (RTL) code/data) may be used to generate GDS data, GDSII data and the like. GDSII data, for example, is a descriptive file format and may be used in different embodiments to represent a three-dimensional model of a semiconductor product or device. Such models may be used by semiconductor manufacturing facilities to create semiconductor products and/or devices. The GDSII data may be stored as a database or other program storage structure. This data may also be stored on a computer readable storage device (e.g., storage 910, disks 920, 925, solid state storage, and the like). In one embodiment, the GDSII data (or other similar data) may be adapted to configure a manufacturing facility (e.g., through the use of mask works) to create devices capable of embodying various aspects of the disclosed embodiments. In other words, in various embodiments, this GDSII data (or other similar data) may be programmed into the computing apparatus 900, and executed by the processor 905 using the application 965, which may then control, in whole or part, the operation of a semiconductor manufacturing facility (or fab) to create semiconductor products and devices. For example, in one embodiment, silicon wafers containing portions of the computer system 100 illustrated in FIGS. 1-8 may be created using the GDSII data (or other similar data).

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A processor, comprising:
a first processing unit; and
a first level cache associated with the first processing unit and operable to store data for use by the first processing unit used during normal operation of the first processing unit, wherein the first processing unit is operable to store first architectural state data for the first processing unit in the first level cache responsive to receiving a power down signal.

2. The processor of claim 1, further comprising:
a cache controller; and
a second level cache, wherein the cache controller is operable to flush contents of the first level cache to the second level cache prior to the processor powering down the first processing unit and the first level cache, the contents including the first architectural state data.

3. The processor of claim 2, wherein the first processing unit is operable to retrieve the first architectural state data from the second level cache responsive to receiving a power restore signal.

4. The processor of claim 3, further comprising a second processing unit associated with a second first level cache, wherein the second processing unit is operable to store second architectural state data for the second processing unit in the second first level cache responsive to receiving a power down signal for the second processing unit.

5. The processor of claim 4, wherein the cache controller is operable to flush contents of the second first level cache to the second level cache prior to the processor powering down the second processing unit and the second first level cache, the contents including the second architectural state data.

6. The processor of claim 5, further comprising a third level cache, wherein the cache controller is operable to flush the contents of the second level cache to the third level cache prior to the processor powering down the first and second processing units and the first and second first level caches, the contents including the first and second architectural state data.

7. The processor of claim 6, wherein the first processing unit is operable to retrieve the first architectural state data from the third level cache responsive to receiving a power restore signal.

8. A processor, comprising:
a plurality of processing units;
a cache controller; and
a cache hierarchy including a plurality of levels coupled to the plurality of processing units, wherein the plurality of processing units are operable to store respective architectural state data in a first level of the cache hierarchy responsive to receiving respective power down signals, and the cache controller is operable to flush contents of the first level including the respective architectural state data to a first lower level of the cache hierarchy prior to the processor powering down the first level of the cache hierarchy and any processing units associated with the first level of the cache hierarchy.

9. The processor of claim 8, wherein the cache controller is operable to flush contents of the first lower level to a second lower level of the cache hierarchy prior to the processor powering down the first lower level of the cache hierarchy and any processing units associated with the first lower level of the cache hierarchy.

10. The processor of claim 8, wherein the processor is operable to restore power to at least one of the plurality of processing units, and the restored processing unit is operable to retrieve its associated architectural state data from the cache hierarchy.

11. The processor of claim 8, wherein each processing unit has an associated designated memory location for storing its respective architectural state data, and the restored processing unit is operable to retrieve its associated architectural state data from the cache hierarchy based on its designated memory location.

12. The processor of claim 8, wherein the plurality of processing units comprises at least one of a processor core or a graphics processing unit.

13. A computer system, comprising:
a processor comprising:
a plurality of processing units; and
a plurality of cache memories coupled to the plurality of processing units;
a system memory coupled to the processor, wherein a memory hierarchy including a plurality of cache levels and at least one system memory level below the cache levels is defined by the plurality of cache memories and the system memory; and
a power management controller operable to send a power down signal to at a first processing unit in the plurality of processing units, wherein the first processing unit is operable to store first architectural state data for the first processing unit in a first level of the memory hierarchy responsive to receiving a power down signal.

14. The system of claim 13, further comprising a cache controller operable to flush contents of the first level of the memory hierarchy to a second level of the memory hierarchy prior to the processor powering down the first processing unit and the first level of the memory hierarchy, the contents including the first architectural state data.

15. The system of claim 14, wherein the first processing unit is operable to retrieve the first architectural state data from the memory hierarchy responsive to receiving a power restore signal from the power management controller.

16. The system of claim 15, wherein the first processing unit has an associated designated memory location for storing its respective architectural state data, and the first processing unit is operable to retrieve the first architectural state data from the cache hierarchy based on its designated memory location.

17. The system of claim 14, wherein the cache controller is operable to flush contents of the second level of the memory hierarchy to a third lower level of the cache hierarchy prior to the processor powering down the second level of the cache hierarchy and any processing units associated with the second level of the cache hierarchy.

18. The system of claim 13, wherein the plurality of processing units comprises at least one of a processor core or a graphics processing unit.

19. A method for controlling power to processor including a hierarchy of cache levels, comprising:
storing first architectural state data for a first processing unit of the processor in a first level of the cache hierarchy responsive to receiving a power down signal, and
flushing contents of the first level including the first architectural state data to a first lower level of the cache hierarchy prior to powering down the first level of the cache hierarchy and the first processing unit.

20. The method of claim 19, further comprising flushing contents of the first lower level to a second lower level of the cache hierarchy prior to powering down the first lower level of the cache hierarchy.

21. The method of claim 20, further comprising:
restoring power to the first processing unit; and
retrieving the first architectural state data from the cache hierarchy.

22. The method of claim 21, wherein the first processing unit has an associated designated memory location for storing its respective architectural state data, retrieving the first architectural state data from the cache hierarchy comprises retrieving the first architectural state data from the cache hierarchy based on the designated memory location.

23. The method of claim 19, wherein the processor includes a plurality of processing units, further comprising flushing contents of a particular level of the cache hierarchy to a level lower than the particular level prior to powering down the particular level of the cache hierarchy and any processing units associated with the particular level of the cache hierarchy.

24. A computer readable storage device encoded with data that, when implemented in a manufacturing facility, adapts the manufacturing facility to create a processor, comprising:
a first processing unit; and
a first level cache associated with the first processing unit and operable to store data for use by the first processing unit used during normal operation of the first processing unit, wherein the first processing unit is operable to store first architectural state data for the first processing unit in the first level cache responsive to receiving a power down signal.
